(19) United States
(12) Patent Application Publication
(10) Pub. No.: US 2004/0174481 A1
(43) Pub. Date: Sep. 9, 2004

(54) Liquid crystal display and manufacturing method thereof

(76) Inventors: Chen-Chi Lin, Taoyuan City (TW); Chuen-Ru Lee, Taoyuan (TW); Szu-Fen Chen, Taoyuan Hsien (TW); Sheng-Hsiung Hou, Kaohsiung (TW)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/743,821

(22) Filed: Dec. 24, 2003

(30) Foreign Application Priority Data
Mar. 4, 2003 (TW) 92104590

(51) Int. Cl. G02F 1/1337; G02F 1/1339

(52) U.S. Cl. 349/129; 349/156

(57) ABSTRACT

A structure of liquid crystal display (LCD) and a manufacturing method thereof are disclosed, wherein photoresist is used to form bottom bumps of square frame shape on the thin film transistor (TFT) substrate, and top bumps of H shape are formed on the color filter (CF) substrate. After aligning and combining two substrates, both top and bottom bumps can be stacked together to form overlapped areas. By arranging the top bumps and the bottom bumps, ratio of liquid crystal molecules arranged in different directions between two substrates can be controlled, thereby obtaining a wide uniform view angle.

### FIELD OF THE INVENTION

The present invention relates to liquid crystal display technology, and more particularly to a liquid crystal display (LCD) with wide view angle aid a manufacturing method thereof.

### BACKGROUND OF THE INVENTION

Liquid crystal displays have the advantages of excellent image quality, small volume, light weight, low driving voltage, low power consumption and broad application range, and are widely applied in the consumer electronic products or computer products, such as medium to small portable TVs, mobile phones, camcorders, notebooks, desktop monitors and projection TVs, etc. Further, LCDs have gradually replaced cathode ray tubes (CRTs) and become the main stream of display devices.

The main body of LCD commonly is a liquid crystal unit, which is mainly composed of two transparent substrates and a liquid crystal layer sealed between the transparent substrates. Currently, thin film transistor (TFT) LCD is the major trend of the liquid crystal display, and the fabrication of the TFT LCD can be commonly divided into four parts: a TFT array process, a color filter (CF) process, a liquid crystal cell assembly process and a liquid crystal module (LCM) process.

In the above, a color filter substrate is fabricated during the color filter process, and there are a color filter layer consisting of the color filter array with various colors, and a black matrix layer surrounding the color filter array formed on the color filter substrate. Generally, the material forming the color filter layer is colored photoresist, and the black matrix layer is made of the material, such as chromium/chromium oxide or epoxies, different from the colored photoresist.

Recently, the market of LCD is under prosperous and rapid development, and especially, the demands for notebook and monitor applications have been continuously increasing. However, when various electronic information products of desktop monitors, auto navigation displays, hang-on-the-wall TVs and high-resolution TVs, etc. fabricated with large-size and high-resolution LCD panel process have been greatly presented to the market, the requirements of wide view angle and fast response speed have become even more important. Not only the requirements of angular brightness contrast, gray-scale inversion, colors, and LCD optical response have to be taken into consideration, but also the LCD design with effective cost is needed.

A method of controlling multi-domain liquid crystal molecules is the most important technique for obtaining a wide view angle of a LCD, and the method is to divide each pixel into multiple domains with a flat panel display technique, thereby compensating optical asymmetry, and broadening the view angle of the LCD. The conventional multi-domain LCDs mostly belong to the twisted nematic (TN) mode, and include orthogonal ploarizers added to the exterior of a LCD panel. The conventional multi-domain LCDs have some inherent shortcomings, such as complicated process, low yield, left and right view angle of about ±70 degrees, top and bottom view angles of about ±60 degrees, response speed of about 50 ms, and bad light dispersion effect, so that the conventional multi-domain LCDs are difficult to be applied in the products demanding high quality. Meanwhile, the unidirectional rubbing technique used in the conventional multi-domain LCD is quite complicated in process.

Due to the requirement of wide view angle for the high-quality products, the structure of multi-domain vertically aligned (VA) LCD is developed accordingly. In this type of multi-domain vertically aligned LCD, a couple of bumps need to be fabricated inside two substrates of the LCD, for orienting liquid crystal molecules in one single pixel towards different directions, thereby achieving the function of wide view angle.

FIG. 1 is a top view illustrating a general multi-domain vertically aligned LCD. Referring to FIG. 1, the general multi-domain vertically aligned LCD is to form square-frame-shaped bumps 10 respectively on a TFT substrate and a color filter substrate, and to form cross-shaped bumps 12 on color filter elements. After the step of aligning and combining those two top and bottom substrates together by pressing and assembling the LCD panel, etc., the gap of the liquid crystal cell is formed naturally. Further, the cross-shaped bumps 12 are used to control liquid crystal molecules 14 arranged towards four directions, thus forming a multi-domain structure.

However, when the LCD is driven, the tilt and inclination ratios towards various directions for the liquid crystal molecules 14 are different, thus resulting in that different view angles of top, bottom, left and right, and causing poor view angle symmetry of the LCD.

### SUMMARY OF THE INVENTION

The object of the present invention is to disclose a LCD and a manufacturing method thereof, for improving the tilt and inclination ratios towards various directions for the liquid crystal molecules, thereby promoting the view angle symmetry.

According to the aforementioned object, the present invention provides a LCD comprising a pair of substrates that are parallel to each other, at least one square-frame-shaped bump and at least one H-shaped bump respectively located on two substrates. The square-frame-shaped bump is opposite to the H-shaped bump, and a portion of the H-shaped bump contacts the square-frame-shaped bump to form overlapped areas. Further, a liquid crystal layer is located between two substrates, and is filled completely in the area between the square-frame-shaped bump and the H-shaped bump.

With regard to the LCD manufacturing method of the present invention, at first, a pair of substrates that are parallel to each other are provided. Then, at least one square-frame-shaped bump is formed on one substrate, and at least one H-shaped bump is formed on the other substrate. Thereafter, the square-frame-shaped bump and the H-shaped bump are forced to face to each other, and then two substrates are mutually aligned and combined together by pressing, so that a portion of the H-shaped bump contacts the square-frame-shaped bump, so as to form at least one overlapped area. Further, liquid crystal molecules are filled in the area between two substrates after the aforementioned steps are performed.

By using the aforementioned LCD and manufacturing method according to the present invention, the full view angle of various directions can reach above 85%, and the contrast ratio can be more than 500.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a top view illustrating a general multi-domain vertically aligned LCD;

FIG. 2 is a top view illustrating a LCD of the present invention; and

FIG. 3 is a schematic diagram sketching the cross-sectional view of the structure along line A-A′ shown in FIG. 2.

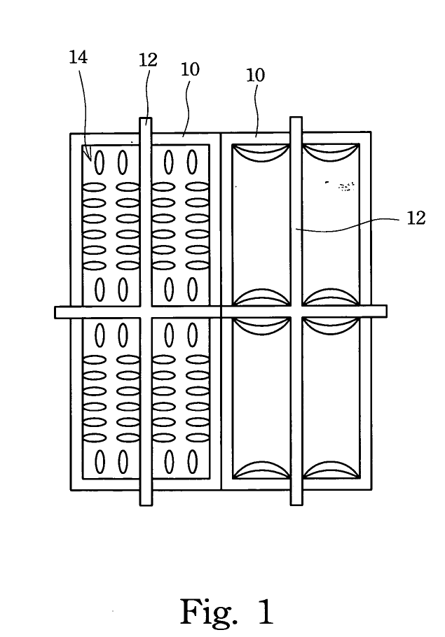

### DETAILED DESCRIPTION OF THE PREFERRED EMBODIMENT

In the following, a preferred embodiment accompanying with figures is used to explain a LCD and a manufacturing method thereof, according to the present invention.

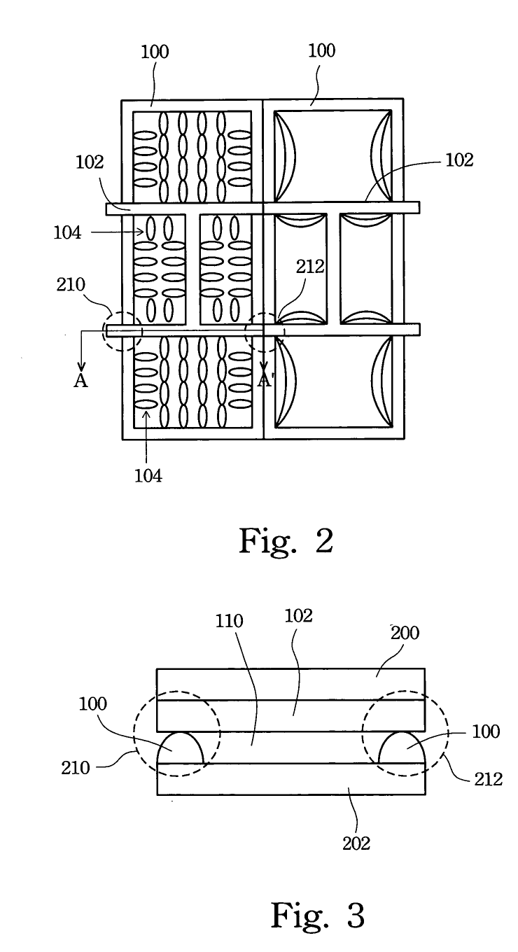

FIG. 2 is a top view illustrating a LCD of the present invention, and FIG. 3 is a schematic diagram sketching the cross-sectional view of the structure along line A-A′ shown in FIG. 2. Please refer to FIG. 2 and FIG. 3. At first, a pair of substrates 200 and 202 that are parallel to each other in the directions of top and bottom are provided, wherein one substrate 202 used for fabricating the structure of TFT has a pixel electrode layer (not shown), and the other substrate 200 used for fabricating a color filter has a common electrode layer (not shown).

Thereafter, on the substrate 202 containing pixel electrode layers, bumps 100 are formed around the pixel electrode layers. Since a bump 100 encloses a pixel electrode layer, the shape of the bump 100 is a square frame shape. Such as shown from the top view, the entire substrate 202 containing the pixel electrode layers appears in the shape of grids, due to the square-frame-shaped bump 100. Meanwhile, bumps 102 of H shape are formed on the other substrate 200 containing the common electrode layer.

The aforementioned square-frame-shaped bumps 100 and H-shaped bumps 102 can be formed by using a general backside exposure technique or photolithographic process to perform the steps of providing substrates, coating photoresist, pre-baking, exposing, developing and hard baking, so as to form the square-frame-shaped bumps 100 and H-shaped bumps 102 made of photoresist on the TFT substrate 202 and the color filter substrate 200.

The photoresist forming the bumps can be either a positive photoresist or a negative photoresist, and the material thereof is not limited. However, in a preferred embodiment of the present invention, the photoresist preferably has a dielectric constant smaller than the dielectric constant of the liquid crystal molecules.

Thereafter, an alignment film layer (not shown) is formed respectively on the bump 100 and the bump 102 which are located on the substrate 200 and the substrate 202, and then the substrate 200 and the substrate 202 are mutually aligned in the directions of top and bottom and combined by pressing, so as to naturally form a gap of a liquid crystal cell 110 by overlapping the square-frame-shaped bump 100 and the H-shaped bump 102. Thereafter, the LCD is completely fabricated by performing the steps, such as cutting, splitting, injecting liquid crystal, sealing, forming compensation films and attaching polarization surfaces and assembling a LCD panel, etc., wherein polarizers are located on the exterior side of the combined top and bottom substrates, and compensation films are located between the polarizers and the substrates. For the color filter substrate 200, the polarizer and the compensation film are located on the side different from where the bumps 102 are located. For the substrate 202 having the pixel electrode layer, the polarizer and the compensation film are located on the side different from where the bumps 100 are located. However, since the aforementioned description is not the main point of the present invention, it will not be stated in detail herein.

When the LCD of the present invention fabricated by the aforementioned process is driven, the tilt and inclination ratio of the liquid crystal molecules 102 are very close or the same in various directions, such as shown in FIG. 2. Therefore, the view angles formed in the directions of top, bottom, left and right are uniform, so that the view angles of the LCD are symmetrical.

The structure and manufacturing method of the present invention are featured in that the TFT substrate 202 has the square-frame-shaped bumps 100 and the color filter substrate 200 has the H-shaped bumps 102. Hence, after the color filter substrate 200 and the TFT substrate 202 are mutually aligned and combined by pressing, the entire H-shaped bump 102 is fully disposed on the square-frame-shaped bump 100 because portions of the H-shaped bump 102 contact the square-frame-shaped bump 100 (such as shown by overlapped areas 210 and 212), thereby naturally forming the gap of the liquid crystal cell 110.

It is worthy to be noted that the cross-sectional shape of the H-shaped bump 102 and that of the square-frame-shaped bump 100 as shown in FIG. 3 are merely stated as an example for explanation, and the shapes thereof can be arbitrarily selected as a dome-type protrusion shape, a cubic-type protrusion shape or a prism-type protrusion shape, etc., but the present invention is not limited thereto. Meanwhile, with the arbitrarily-determined heights of the H-shaped bump 102 and square-frame-shaped bump 100 and the different ways in which the bumps of various shaped are in contact, the height of the gap of the liquid crystal cells 110 can be controlled. Further, since the heights of the bumps 100 and 102 on the substrates 200 and 202 can be used to control the gap, the uniformity of the gap can be controlled effectively. Thus, with the addition of spacer, light leakage and the lowered contrast due to the slide of the spacer in shaking can be further prevented from affecting the LCD quality.

In the preferred embodiment of the present invention, the LCD manufactured by the aforementioned method not only broadens the view angles of various directions to more than 85% and make the view angles even more uniform, but also raises the contrast to more than 500. Accordingly, the LCD and the manufacturing method of the present invention are really the technology that can fabricate a LCD better than the conventional LCDs in quality.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A liquid crystal display (LCD) module, comprising
at least one square-frame-shaped bump, located on a first substrate;
at least one H-shaped bump, located on a second substrate, wherein, when said first substrate and said second substrate are assembled, said square-frame-shaped bump is opposite to said H-shaped bump, and a portion of said H-shaped bump contacts a portion of said square-frame-shaped bump, so as to form at least one overlapped area; and
a liquid crystal layer, wherein said liquid crystal layer is located between said first substrate and said second substrate, and said liquid crystal layer is filled in the area between said square-frame-shaped bump and said H-shaped bump;
a thin film transistor (TFT), wherein said TFT is located on one of said first substrate and said second substrate; and
a color filter (CF), wherein said color filter is located on one of said first substrate and said second substrate.

2. The LCD module of claim 1, wherein said first substrate has a polarizer, and said polarizer and said square-frame-shaped bump are located on different sides of said first substrate.

3. The LCD module of claim 2, wherein said first substrate has at least one compensation film, and said compensation film is located between said first substrate and said polarizer.

4. The LCD module of claim 1, wherein said second substrate has a polarizer, and said polarizer and said H-shaped bump are located on different sides of said second substrate.

5. The LCD module of claim 4, wherein said second substrate has at least one compensation film, and said compensation film is located between said second substrate and said polarizer.

6. The LCD module of claim 1, wherein said square-frame-shaped bump and said H-shaped bump are made of photoresist material.

7. The LCD module of claim 1, wherein the cross-sectional shape of said square-frame-shaped bump is selected from a group consisting of a dome-type protrusion shape, a cubic-type protrusion shape and a prism-type protrusion shape.

8. The LCD module of claim 1, wherein the cross-sectional shape of said H-shaped bump is selected from a group consisting of a dome-type protrusion shape, a cubic-type protrusion shape and a prism-type protrusion shape.

9. The LCD module of claim 1, wherein the dielectric constant of said square-frame-shaped bump and the dielectric constant of said H-shaped bump are smaller than the dielectric constant of said liquid crystal layer.

10. A LCD manufacturing method, comprising:
providing a first substrate and a second substrate;
forming at least one square-frame-shaped bump on said first substrate;
forming at least one H-shaped bump on said second substrate;
forcing said square-frame-shaped bump and said H-shaped bump to face to each other, and to be mutually aligned and combined together by pressing, wherein a portion of said H-shaped bump contacts a portion of said square-frame-shaped bump, so as to form at least one overlapped area; and
filling a liquid crystal layer in the area between said first substrate and said second substrate.

11. The LCD manufacturing method of claim 10, wherein the process for fabricating said square-frame-shaped bump is selected from a group consisting of a photolithographic process and a backside exposure process.

12. The LCD manufacturing method of claim 10, wherein the process for fabricating said H-shaped bump is selected from a group consisting of a photolithographic process and a backside exposure process.

13. The LCD manufacturing method of claim 10, further comprising first forming at least one pixel electrode on said first substrate, and then forming said square-frame-shaped bump, wherein said square-frame-shaped bump encloses said pixel electrode.

14. The LCD manufacturing method of claim 10, further comprising first forming at least one common electrode on said second substrate, and then forming said square-frame-shaped bump on said common electrode layer, wherein said square-frame-shaped bump encloses said pixel electrode.

15. The LCD manufacturing method of claim 10, further comprising attaching a compensation film to said first substrate.

16. A liquid crystal display (LCD), comprising
a first substrate, wherein said first substrate has at least one pixel electrode and a TFT;
a second substrate parallel to said first substrate, wherein said second substrate has at least one common electrode layer and a color filter;
at least one square-frame-shaped bump, located on said first substrate, wherein said square-frame-shaped bump encloses said pixel electrode;
at least one H-shaped bump, located on said second substrate, wherein, when said first substrate and said second substrate are assembled, said square-frame-shaped bump is opposite to said H-shaped bump, and a portion of said H-shaped bump contacts a portion of said square-frame-shaped bump, so as to form at least one overlapped area; and
a liquid crystal layer, wherein said liquid crystal layer is located between said first substrate and said second substrate, and said liquid crystal layer is filled in the area between said square-frame-shaped bump and said H-shaped bump.

17. The LCD of claim 16, wherein said first substrate has a polarizer and at least one compensation film, and said polarizer and said compensation film are located on one side of said first substrate different from where said square-frame-shaped bump is located, and said compensation film is located between said first substrate and said polarizer.

18. The LCD of claim 16, wherein said second substrate has a polarizer and at least one compensation film, and said polarizer and said compensation film are located on one side of said second substrate different from where said H-shaped bump is located, and said compensation film is located between said second substrate and said polarizer.
